(19) United States
(12) Patent Application Publication
(10) Pub. No.: US 2010/0109249 A1
(43) Pub. Date: May 6, 2010

(54) STRIP FOR CONNECTING AND/OR SEALING A JOINT

(76) Inventors: Christian Ibsen, Tonder (DK); Ole Andersen, Tjaereborg (DK)

Correspondence Address: VEDDER PRICE P.C., 222 N. LASALLE STREET, CHICAGO, IL, 60601, US

(21) Appl. No.: 12/529,839

(22) PCT Filed: Feb. 13, 2008
(86) PCT No.: PCT/DK2008/000070

§ 371 Date: Jan. 11, 2010

(30) Foreign Application Priority Data
Mar. 8, 2007 (DK) PA 2007 00357

(51) Int. Cl. F16J 15/02

(52) U.S. Cl. 277/312; 277/644

(57) ABSTRACT

The present invention relates to a strip for connecting and/or sealing a joint. Said strip comprises a first layer and a reinforcement element. Said strip having a first surface and a second surface, said first and second surfaces have a longitudinal extension and a transverse extension, said longitudinal extension having longitudinal sides, the longitudinal sides comprises edge means. Said first layer and/or edge means is made of polymeric material. Furthermore, said first layer and edge means hermetically cover the reinforcement element, and said edge means during the connecting and/or sealing of the joint provide a slope, said slope extending from the first surface downwards against a plane, said plane substantially being aligned with the second surface, so that the edge means enhances the adhesion of the strip to the joint. The invention also relates to methods for manufacturing the strip as well as to uses of said strip.

### TECHNICAL FIELD OF THE INVENTION

The present invention relates to a strip for connecting and/or sealing a joint, said strip comprises a first layer and a reinforcement element, said strip having a first surface and a second surface, said first and second surfaces having a longitudinal extension and a transverse extension, said longitudinal extension having longitudinal sides, the longitudinal sides comprise edge means, said first layer and/or edge means is made of polymeric material.

The invention also relates to methods for manufacturing the strip as well as to uses of said strip.

The term “joint” are in this context construed as one or more pieces of material being assembled.

### BACKGROUND ART

In the prior art, it is known to connect and seal joints by using a strip. Said strip has a first surface and a second surface as well as a longitudinal extension and a transverse extension. The longitudinal extension of the strips has longitudinal sides. The known strips may be flexible strips or any type of woven cords.

In one example of the manufacturing of the known strips, a fabric is cut into a plurality of strips whereby the longitudinal sides are formed with a sharp edge. The cross-sectional view of a known strip is thus substantially square.

When the strip has been applied onto the joint, the strip is adhered to the material below, for instance by using adhesives or by heating or melting. After the strip has been adhered to the joint, the sharp edge of the longitudinal sides of the strip is exposed. This has the disadvantage that it is possible for an object or a person to catch the sharp edge, when moving the object lateral over the strip. This may have the severe consequence, that the strip may be released from the material and that the joint thereby become loose. This is especially a problem when the strip is being used in connection with assembling joints in inflatable units, where it is important that the physical connection of the joint is secure and difficult to destroy.

In the prior art, this is solved by, after the strip has been adhered onto the joint, supplying the sharp edges with an adhesive or glue or similar material so that the transition between the sides of the strip and the material below becomes more smooth.

However, this approach has several disadvantages, namely that it takes several working operations and thereby considerably higher costs in manufacturing the product. Furthermore, the supply of additional material or adhesives to the sharp edges requires high quality in the process for securing the adhesion and that the joint after it have been supplied with the additional material have the right appearance.

A further disadvantage in the known joints used in connection with inflatable units is that gasses or fluids may leak along the joint and that they may escape where there is a leak between the strip and the material. Whereby it may be difficult to find the exact place wherein the leakage is.

Furthermore, when the known strips comprise a reinforcement element, such as textile, it has the additional disadvantage that gasses may move along as well as transversely in the textile. Hereby, the gasses may escape where the reinforcement element, i.e. textile, is exposed to the environment, which is often a completely different place than the actual leakage spot.

Furthermore, when more than two materials are to be joined or if a joint is to be strengthened, additional strips are applied to the material, either along with or transversely to a previously applied strip. This procedure is also problematic in the prior art due to the sharp edges of the strip and thereby the lack of adhesion between the strips especially at the edge of the bottom strip.

### SUMMARY OF THE INVENTION

An object of the present invention is to wholly or partly overcome the above disadvantages and drawbacks of the prior art. More specifically, it is an object to provide a strip, which facilitates connection and/or sealing of a joint.

Furthermore, it is an object of the present invention to provide a strip having a reinforcement element, wherein leakage from longitudinal and/or transverse movement of gasses within the reinforcement element substantially is avoided.

It is also an object of the present invention to provide a strip, which may be applied onto a joint using only one working operation.

Another object of the present invention is to provide methods for manufacturing a strip.

The above objects, together with numerous other objects, advantages and features, which will become evident from the below description, are accomplished by a solution in accordance with the present invention by said first layer and edge means hermetically cover the reinforcement element, and said edge means during the connecting and/or sealing of the joint provide a slope, said slope extending from the first surface downwards against a plane, said plane substantially being aligned with the second surface, so that the edge means enhances the adhesion of the strip to the joint.

Hereby a strip is obtained, which has high strength properties, due to the reinforcement element, and wherein it is avoided that the gasses, which may leak from the joint and subsequently move within the reinforcement element both in a longitudinal and transverse direction substantially will not leak into the environments due to the reinforcement element being substantially hermetically covered by the first layer as well as the edge means.

Furthermore, a strip is obtained which facilitates the application of the strip and thereby the connection and/or sealing of the joint. Furthermore, the adhesion of the strip to the joint is considerably enhanced and thereby both the strength of the joint as well as tightness of the joint. Additionally, by the strip comprising the sloped edge means at the longitudinal sides it is obtained that the strip, when it has been applied and adhered to the joint, has a smooth edge, which minimizes the risk for something catching the edge and thereby that the strip can be released from the materials and that the joint thereby becomes loose.

The matter is that after the strip has been applied onto the joint, which is to be connected and/or sealed, only one working operation is necessary for adhering the strip to the joint. Hereby, the many working operations of the prior art are avoided.

In a preferred embodiment according to the invention, the edge means may be integrated with the side of the strip or be indirectly connected to the side of the strip.

According to the invention, the strip may have a thickness between 0.05 mm and 30.00 mm.

In an expedient embodiment according to the invention, the edge means, before it is applied to the joint, may have a cross-sectional triangular, round, square, half-circular, curved or elliptic configuration or a combination thereof. The cross-sectional configuration may be optional, and may be chosen in view of the material used. For instance the cross-sectional configuration may be isosceles triangle, right-angled triangle, acute-angled triangle, zigzagged, curved, parallelogram, etc.

Advantageously, the cross-sectional configuration of the edge means, before it is applied to the joint, may be symmetrical, preferably of a right-angled triangle configuration.

According to the invention, the slope may have an angle between 15 and 60 degrees from the second surface, preferably between 30 and 45 degrees, which enhances the adhesion of the strip to the joint.

According to the invention, the edge means and the strip may substantially be made of the same material or of material(s) having substantially the same composition(s) and properties.

In a preferred embodiment according to the invention, the polymeric material natural rubber (NR) polyurethane (PU), thermoplastic poly urethane (TPU), butyl rubber (BR), polyvinylchloride (PVC), polychloroprene (CR), polyethylene (PE) or a combination thereof.

Furthermore, the polymeric material may have weldable properties. According to the invention, the edge means may be made of a flexible material. In an expedient embodiment according to the invention, the reinforcement element may be a textile. Hereby, a strip is obtained, which has the capability to absorb and withstand tensile strength so that the strip can keep the joint in the right position.

Also according to the invention, the reinforcement element may comprise fibres made of a polymeric material, such as polyaramide, polyester, polyamide, polypropylene, polyethylene, metal, glassfibre or a combination thereof.

Advantageously according to the invention, a second layer may be arranged on the opposite side of the reinforcement element in relation to the first layer.

In a further embodiment of the invention, the second side of the strip may comprise adhesives.

Advantageously, the strip may be connected and/or sealed to the joint by using adhesives, curing, welding or heating.

According to a preferred embodiment of the invention, the strip may be impermeable to gasses and/or liquids. Hereby is obtained that the strip may be used in connection with e.g. inflatable units, such as liferafts.

The invention also relates to a method for manufacturing a strip according to the invention. Said method comprising the steps of:

feeding a strip with a predetermined width to a connection device,

adding material to at least one of the longitudinal sides of the strip, and

forming the material into the edge means.

After the forming of the edge means of the strip, the strip according to the invention is ready for use.

Furthermore, the strip may be pre-heated before the material is added. In addition, the strip may be pre-cooled after the material is added. The pre-cooling of the added material facilitates the forming process of the edge means. Moreover, the strip may be cooled after the forming step. Also, the adding of material may be performed by melting, cementing, gluing or extruding. The forming step may according to the invention be performed by rolling.

The invention also relates to another method for manufacturing a strip according to the invention. Said method comprising the steps of:

positioning a strip with a predetermined width, and

moving a connection device along the strip while
adding material to at least one of the longitudinal sides of the strip, and
forming the material into the edge means.

After the forming of the edge means of the strip, the strip according to the invention is ready for use.

The invention furthermore relates to another method for manufacturing a strip according to the invention. Said method comprising the steps of:

positioning a reinforcement element with a predetermined width,

placing a coating layer with a width larger than the reinforcement element onto the reinforcement element so that the larger width of the coating layer extends outwards from the width of the reinforcement element, whereby edge means of the strip is formed. After the forming of the edge means of the strip, the strip according to the invention is ready for use. The placing step may be performed by positioning a folio as the coating layer or by extruding the coating layer onto the reinforcement layer.

According to the invention the strip may be used for connecting and/or sealing joints in the manufacturing and/or maintenance of inflatable units, such as liferafts, rubber boats, life jackets or evacuation slides, or for parts to the inflatable units, such as canopies, covers, and the like, or for garments, such as protective wear, survival suits, water-proof clothing or sports wear.

According to the invention the strip may be used for connecting and/or sealing joints in the manufacturing and/or maintenance of tarpaulins, canopies, covers, sails, bouncy castles, air mattresses or containers for liquids.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows a strip according to the invention in a perspective view,

FIG. 2 shows one embodiment of a cross-section of a strip according to the invention,

FIG. 3 shows in a cross-sectional view a strip according to the invention applied onto a joint,

FIG. 4 shows in a cross-sectional view a further embodiment of a joint, wherein a second strip is applied transversely over a first strip according to the invention,

FIG. 5 shows in a top view the joint of FIG. 4,

FIG. 6 shows schematically an assembly for manufacturing a strip according to the invention,

FIG. 7 shows schematically another assembly for manufacturing a strip according to the invention,

FIG. 8 shows another embodiment of a cross-section of a strip according to the invention, and

FIG. 9 shows yet another embodiment of a strip in a not applied state.

All the figures are highly schematic and not necessarily to scale, and they show only parts which are necessary in order to elucidate the invention, other parts being omitted or merely suggested.

### DESCRIPTION OF PREFERRED EMBODIMENTS

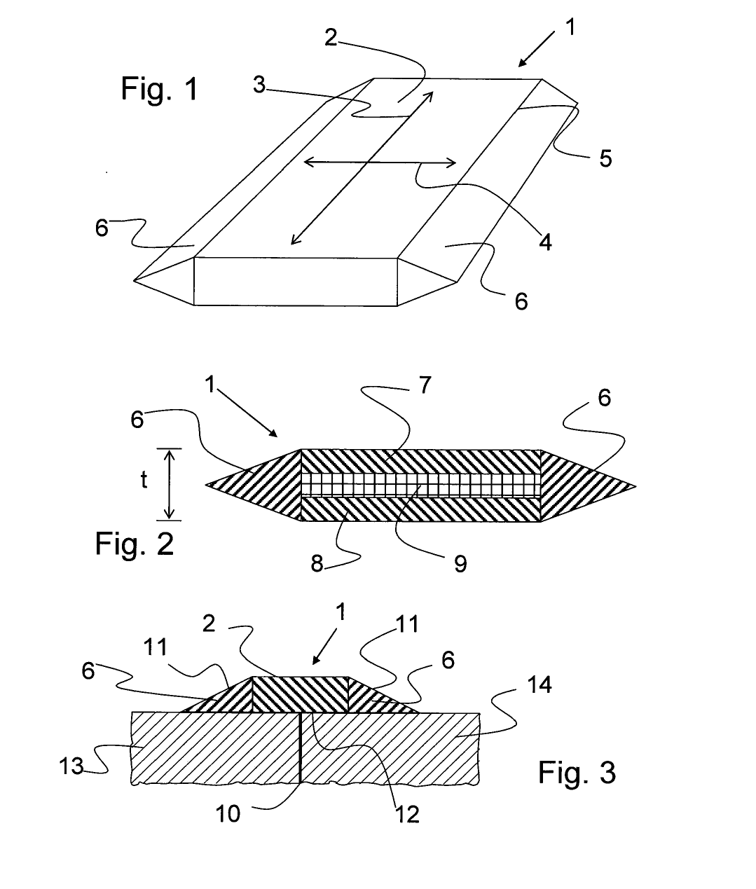

FIG. 1 shows a strip 1 according to the invention in a perspective view. The strip 1 has a first surface 2 and a second surface (not shown), said first 2 and second surfaces having a longitudinal extension 3 and a transverse extension 4, said longitudinal extension 3 having longitudinal sides 5.

According to the invention, at least one of the longitudinal sides 5 comprises edge means 6, which during the connecting and/or sealing of a joint (not shown) provides a slope. The strip 1 is in FIG. 1 shown in a not applied state.

In FIG. 2, an embodiment of a cross-section of a strip 1 according to the invention is shown before it is applied to a joint. In this embodiment, the strip 1 has thickness t, which preferably is between 0.05 mm and 30.00 mm. Also, the edge means 6 of the strip 1 is in this embodiment symmetrical and of a right-angled triangle configuration.

In other not shown embodiments, the edge means, before it is applied to the joint, may have a cross-sectional triangular, round, square, half-circular, curved or elliptic configuration or a combination thereof. The cross-sectional configuration may be optional, and may be chosen in view of the material used. For instance the cross-sectional configuration may be isosceles triangle, right-angled triangle, acute-angled triangle, zigzagged, curved, parallelogram, etc. Furthermore, the edge means may be hollow.

The strip 1 in FIG. 2 is shown as a composite material, comprising a first layer 7 and a second layer 8 as well as a reinforcement layer 9. In this embodiment the second layer 8 is arranged on the opposite side of the reinforcement layer 9 in relation to the first layer 7. In other embodiments according to the invention, the composite material may comprise only two layers, i.e. a first layer and a reinforcement layer. However, the composite material may also comprise a plurality of layers, combined to provide specific properties to the strip.

According to the invention, the edge means 6 and the strip 1 may substantially be made of the same material or of material(s) having substantially the same composition(s) and properties. Furthermore, the strip 1 and/or the edge means 6 may be made of polymeric material, such as natural rubber (NR) polyurethane (PU), thermoplastic polyurethane (TPU), butyl rubber (BR), polyvinylchloride (PVC), polychloroprene (CR), polyethylene (PE) or a combination thereof. Also, it is advantageous when the polymeric material has weldable properties. In a preferred embodiment the strip 1 is made of a material or a combination of materials, which makes the strip impermeable to gasses and/or liquids. This is especially expedient in cases where the strip is to be used for connecting and/or sealing joints, which are to be used in connection with the manufacturing and/or maintenance of inflatable units.

The edge means 6 may also be made of a flexible material, which enables the forming of the edge means 6 to the desired configuration. Also, the edge means may be made of a porous material, which may be deformed by using pressure.

The reinforcement element may be in form of a textile, for instance woven or knitted. The reinforcement element may comprise fibres made of a polymeric material, such as polyaramide, polyester, polyamide, polypropylene, polyethylene, metal, glassfibre or a combination thereof.

In FIG. 3 a strip 1 according to the invention is shown in a cross-sectional view applied onto a joint 10. The edge means 6, which during the connecting and/or sealing of the joint 10 provide or form a slope 11. Said slope 11 extending from the first surface 2 downwards against a plane, said plane substantially being aligned with the second surface 12, so that the edge means 6 enhances the adhesion of the strip 1 to the joint 10 of the two pieces 13, 14 of materials. The two pieces of materials may for instance be the same piece, which is to be assembled as for example a cylinder, or it may be two (or more) materials which are to be assembled. In this embodiment, it is easily deduced that the strip 1 is provided with smooth edges by means of the edge means 6. The slope 11 may have an angle between 15 and 60 degrees from the second surface 12, preferably between 30 and 45 degrees.

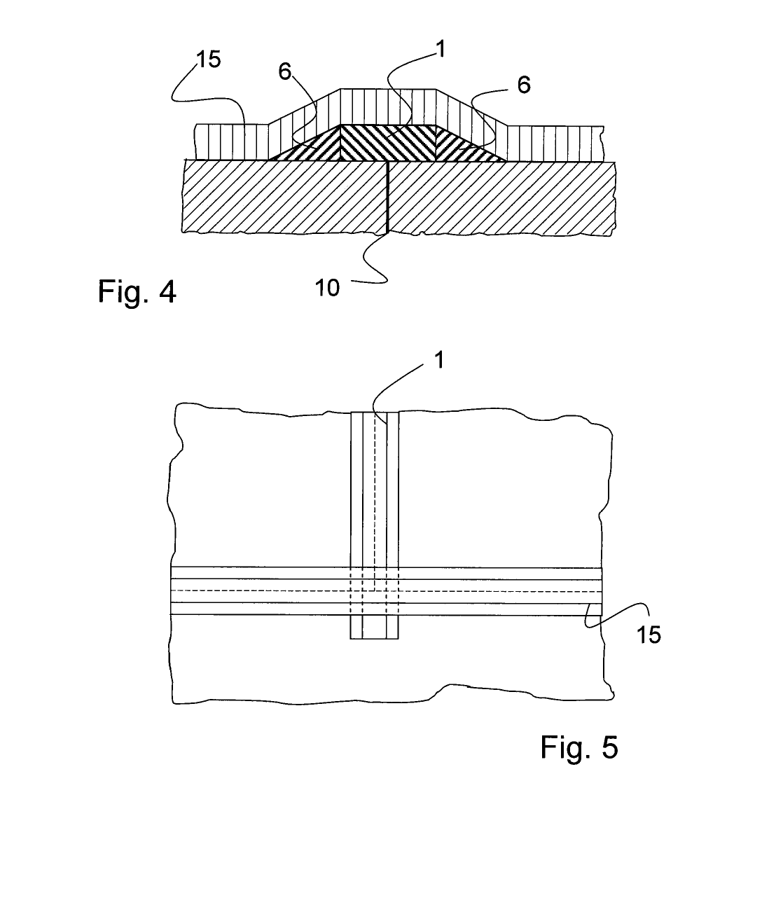

In FIG. 4, the joint 10 shown in FIG. 3 is shown with a second strip 15 applied transversely over the first strip 1. In this embodiment, it is easily deduced that the edge means 6 of the first strip 1 provides slopes on each side of the first strip 1, so that enhanced adhesion of the second strip 15 to the first strip 1 is obtained. In FIG. 5, the joint of FIG. 4 is shown in a top view. In this embodiment, three pieces of material is connected by using two strips 1, 15 according to the invention. In other embodiments (not shown), two or more strips may be used by applying them along each other. The joint 10 has in the shown embodiments been assembling two pieces of material having their surfaces substantially aligned, however, the strip according to the invention may also be used in connection with other joints or applications, for instance with a sealing.

The strip according to the invention may on the second side comprise adhesives, which facilitate the connection of the strip to the joints. Thus, the strip may be connected and/or sealed to the joint by using adhesives, curing, welding or heating.

When the strip according to the invention is to be used to connect and/or seal a joint, the joint is positioned and made ready. Hereinafter, the joint and the surrounding area may optionally be cleansed and/or warmed before the strip is being applied. Subsequently, the strip is applied onto the joint and is adhered to the joint, either by using some sort of adhesive or by using processes such for instance heating, welding or curing. During this adhering process the edge means of the strip is also adhered to the joint and the slope is created, which provides a strip having a smooth edge. Hereinafter, the strip connects and/or seals the joint and it does not need to be processed any further as in the prior art.

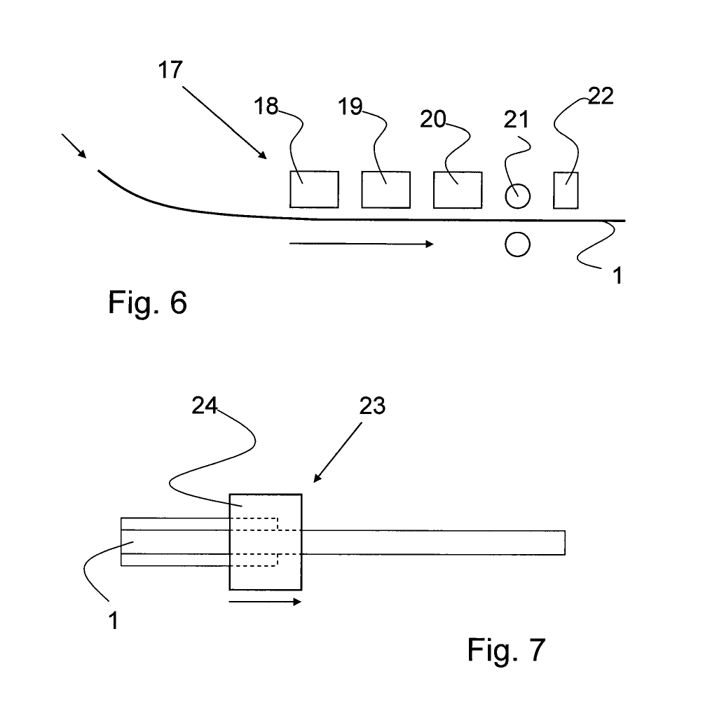

In FIG. 6 an embodiment of an assembly 17 for manufacturing a strip 1 according to the invention is shown schematically. The assembly 17 comprises pre-heating station 18, a connection device 19, a pre-cooling station 20, a forming station 21 as well as cooling station 22.

When the strip according to the invention is being manufactured, a strip having a predetermined width is fed continuously to the assembly 17. The strip has previously been cut out from a textile in the predetermined width and the longitudinal sides of the strip have sharp edges. The strip is then pre-heated in the pre-heating station 18 before it continues to the connection device 19. In the connecting device 19, material is added to at least one of the longitudinal sides of the strip. The material may be added by using melting, cementing, gluing or extruding. After the connecting device 19, the strip may be pre-cooled in the pre-cooling station 20 before it enters the forming station 21, wherein the added material is formed into the edge means. The forming may for instance be performed by rolling. Subsequent to the forming of the edge means, the strip is cooled in the cooling station 22 after the forming step. Following the cooling station 22, the strip 1 according to the invention is manufactured and ready to be used.

FIG. 7 shows schematically another assembly 23 for manufacturing a strip according to the invention. The assembly 23 comprises a connection device 24, which is adapted to move along the longitudinal extension of a strip. The connection device 24 may for instance comprise a heating device, an adding device, a forming device and a cooling device.

When the strip according to the invention is being manufactured, a strip having a predetermined width is positioned and aligned at the assembly 23. The strip has previously been cut out from a textile in the predetermined width and the longitudinal sides of the strip have sharp edges. Hereinafter, the connection device 24 is moved along the strip. While this movement is performed, material is added to at least one of the longitudinal sides of the strip, and the material is formed into the edge means.

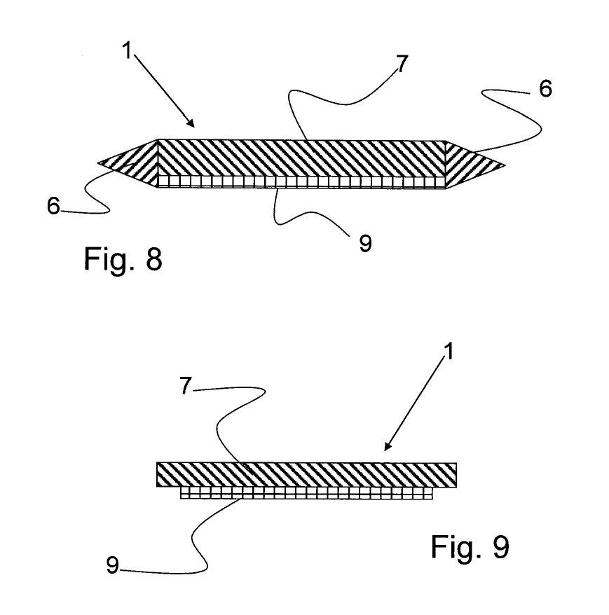

In FIG. 8, a strip 1 according to the invention is shown. The strip 1 comprises in this embodiment a first layer 7, a reinforcement element 9 as well as edge means 6. The strip 1 is shown in a state wherein it is not applied to a joint. When the strip 1 is to be applied to the joint, the reinforcement element 9 is adhered to the joint and thereinafter the edge means 6 is also applied to the joint, whereby the reinforcement element 9 is substantially hermetically covered by the first layer 7 and the edge means 6 so that the exposure of the reinforcement element 9 to the environments is avoided. Hereby it is avoided that the gasses which may leak from the joint and subsequently move within the reinforcement element both in a longitudinal and transverse direction substantially not will leak into the environments due to the reinforcement element being substantially hermetically covered by the first layer as well as the edge means.

In FIG. 9, a strip 1 according to the invention is shown in a not applied state. In this embodiment, the strip 1 has a first layer 7 and a reinforcement element 9. The first layer 7 has a larger width than the reinforcement element 9 whereby the portions of the first layer 7 may be used as edge means, when the strip 1 is applied to a joint. Hereby, the first layer 7 and the edge means in a applied state substantially hermitically cover the reinforcement element 9, so that the reinforcement element 9 is not exposed to the environments. The strip according to the invention may be used for connecting and/or sealing joints in the manufacturing and/or maintenance of inflatable units, such as liferafts, rubber boats, life jackets or evacuation slides, or for parts to the inflatable units, such as canopies, covers, and the like, or for garments, such as protective wear, survival suits, water-proof clothing or sports wear.

The strip according to the invention may also be used for connecting and/or sealing joints in the manufacturing and/or maintenance of tarpaulins, canopies, covers, sails, bouncy castles, air mattresses or containers for liquids.

Although the invention above has been described in connection with preferred embodiments of the invention, it will be evident for a person skilled in the art that several modifications are conceivable without departing from the invention as defined by the following claims.

1. A strip for connecting and/or sealing a joint, said strip comprises a first layer and a reinforcement element, said strip having a first surface and a second surface, said first and second surfaces having a longitudinal extension and a transverse extension, said longitudinal extension having longitudinal sides, the longitudinal sides comprise edge means, said first layer and/or edge means is made of polymeric material, wherein said first layer and edge means hermetically cover the reinforcement element, and said edge means during the connecting and/or sealing of the joint provide a slope, said slope extending from the first surface downwards against a plane, said plane substantially being aligned with the second surface, so that the edge means enhances an adhesion of the strip to the joint.

2. The strip according to claim 1, wherein the edge means is integrated with the side of the strip or indirectly connected to the side of the strip.

3. The strip according to claim 1, wherein the strip has a thickness between 0.05 mm and 30.00 mm.

4. The strip according to claim 1, wherein the edge means has a configuration selected from the group of a cross-sectional triangular, round, square, half-circular, curved or elliptic configuration or a combination thereof

5. The strip according to claim 4, wherein the cross-sectional configuration of the edge means is symmetrical, preferably of a right-angled triangle configuration.

6. The strip according to claim 1, wherein the slope has an angle between 15 and 60 degrees from the second surface.

7. The strip according to claim 1, wherein the edge means and the strip comprise substantially the same material or material(s) having substantially the same composition and properties.

8. The strip according to claim 1, wherein the material comprises a polymer selected from the group of natural rubber, polyurethane, thermoplastic poly urethane, butyl rubber, polyvinylchloride, polychloroprene, polyethylene, or a combination thereof.

9. The strip according to claim 1, wherein the polymeric material has weldable properties.

10. The strip according to claim 1, wherein the edge means comprises a flexible material.

11. The strip according to claim 1, wherein the reinforcement element comprises a textile.

12. The strip according to claim 11, wherein the reinforcement element comprises fibres made of a polymeric material, such as polyaramide, polyester, polyamide, polypropylene, polyethylene, metal, glassfibre or a combination thereof.

13. The strip according to claim 1, wherein a second layer is arranged on the opposite side of the reinforcement element in relation to the first layer.

14. The strip according to claim 1, wherein the second surface of the strip comprises adhesives.

15. The strip according to claim 1, wherein the strip is connected and/or sealed to the joint by using adhesives, curing, welding or heating.

16. The strip according to claim 1, wherein the strip is impermeable to gasses and/or liquids.

17. A method for manufacturing the strip of claim 1, said method comprising the steps of:
feeding a strip with a predetermined width to a connection device,
adding material to at least one of the longitudinal sides of the strip, and
forming the material into the edge means.

18. A method according to claim 17, wherein the strip is pre-heated before the material is added.

19. A method according to claim 17, wherein the strip is pre-cooled after the material is added.

20. A method according to claim 17, wherein the strip is cooled after the forming step.

21. A method according to claim 17, wherein the adding of material is performed by melting, cementing, gluing or extruding.

22. A method according to claim 17, wherein the forming step is performed by rolling.

23. A method for manufacturing a strip according to claim 1, said method comprising the steps of:
positioning a strip with a predetermined width, and
moving a connection device along the strip while
adding material to at least one of the longitudinal sides of the strip, and
forming the material into the edge means.

24. A method for manufacturing a strip according to claim 1, said method comprising the steps of:
positioning a reinforcement element with a predetermined width,
placing a coating layer with a width larger than the reinforcement element onto the reinforcement element so that the larger width of the coating layer extends outwards from the width of the reinforcement element, whereby edge means of the strip is formed.

25. A method according to claim 24, wherein the placing step is performed by positioning a folio as the coating layer or by extruding the coating layer onto the reinforcement layer.

26. Use of the strip according to claim 1 for connecting and/or sealing joints in the manufacturing and/or maintenance of inflatable units, such as liferafts, rubber boats, life jackets or evacuation slides, or for parts to the inflatable units, such as canopies, covers, and the like, or for garments, such as protective wear, survival suits, waterproof clothing or sports wear, or parts thereto.

27. Use of the strip according to claim 1 for connecting and/or sealing joints in the manufacturing and/or maintenance of tarpaulins, canopies, covers, sails, bouncy castles, air mattresses or containers for liquids.
